(19) United States
(12) Patent Application Publication
(10) Pub. No.: US 2017/0088257 A1
(43) Pub. Date: Mar. 30, 2017

(54) UNIFIED CONTROL OF MULTIPLE ACTIVE SYSTEMS FOR HELICOPTER VIBRATION SUPPRESSION

(71) Applicant: Bell Helicopter Textron Inc., Fort Worth, TX (US)

(72) Inventors: David E. Heverly, II, Arlington, TX (US); Rupinder Singh, Houston, TX (US); Taeoh Lee, Keller, TX (US); Michael Smith, Colleyville, TX (US)

(73) Assignee: BELL HELICOPTER TEXTRON INC., Fort Worth, TX (US)

(21) Appl. No.: 14/871,615

(22) Filed: Sep. 30, 2015

(51) Int. Cl. B64C 27/00; F01D 21/00; B64C 27/06; F01D 25/28

(52) U.S. Cl. CPC B64C 27/001; F01D 25/28; F01D 21/003; B64C 27/06; B64C 2027/004

(57) ABSTRACT

A vibration control system for a rotorcraft includes at least one of an integrated actuator and an intermediate actuator associated with a first source of vibration, a sensor configured to sense vibration from the first source of vibration, a dedicated actuator configured for association with a fuselage, and a controller configured to receive information from the sensor and configured to control the dedicated actuator and the at least one of the integrated actuator and the intermediate actuator.

### BACKGROUND

Field of the Invention

The present application relates vibration control systems. In particular, the present application relates to vibration control systems for a cockpit and/or cabin of a rotorcraft.

Description of Related Art

Some rotorcraft comprise vibration control systems associated with controlling vibrations emanating from rotor systems, engines, and/or other sources of vibration. In some cases, the vibration control systems attenuate vibration by controlling the source of the vibration while in other cases vibration is attenuated by providing actuators configured to move a mass in a manner that counteracts the undesirable vibrations. In some cases where a rotorcraft is provided with multiple independent vibration control systems, the vibrations control systems are each independently controlled. Significant room for improvement on vibration control systems remains.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is an orthogonal side view of a rotorcraft according to the present application.

FIG. 2 is a schematic view of a vibration control system of the rotorcraft of FIG. 1.

FIG. 3 is a simplified representation of a general-purpose processor (e.g. electronic controller or computer) system suitable for implementing the embodiments of the disclosure.

FIG. 4 is a flowchart of a method of operating the vibration control system of FIGS. 1 and 2.

FIG. 5 is a schematic diagram of an alternative embodiment of a vibration control system.

While the system and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

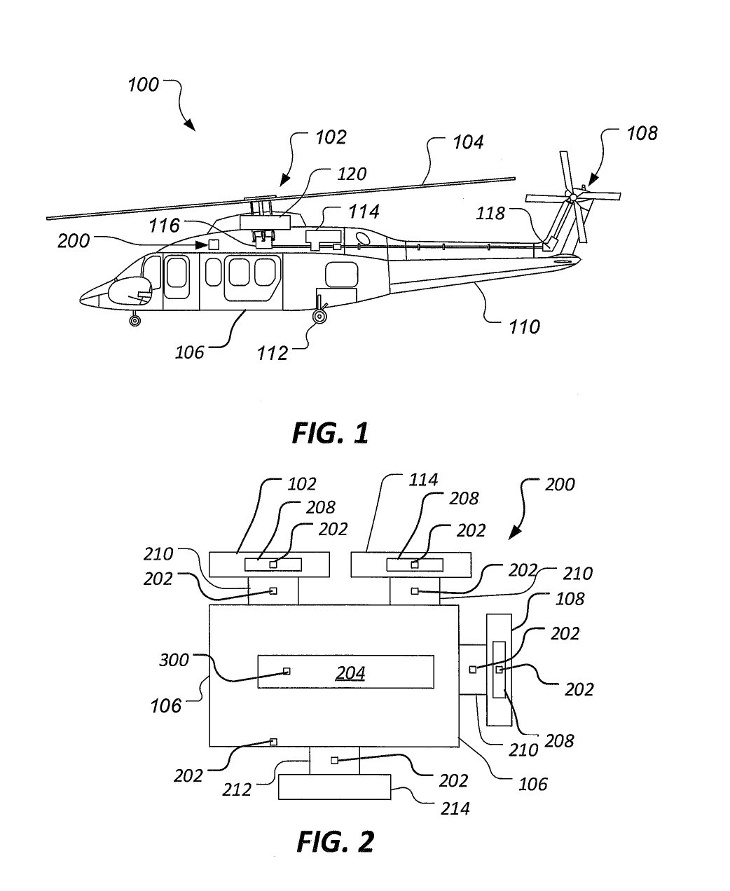

Referring now to FIG. 1 in the drawings, a rotorcraft 100 is illustrated. Rotorcraft 100 comprises a rotor system 102 comprising a plurality of rotor blades 104. A pitch of each rotor blade 104 can be controlled in order to selectively control direction, thrust, and lift of the rotorcraft 100. Rotorcraft 100 further comprises a fuselage 106, anti-torque system 108, and an empennage 110. Rotorcraft 100 further comprises a landing gear system 112 to provide ground support for the aircraft. Rotorcraft 100 further comprises at least one engine 114 configured to drive a main rotor gearbox 116 and a tail rotor intermediate gearbox 118. The rotorcraft 100 further comprises a pylon mount system 120 configured to generally secure the rotor system 102 to the fuselage 106.

Rotorcraft 100 further comprises a vibration control system (VCS) 200 configured to sense vibrations attributable to the rotor system 102, anti-torque system 108, and other sources of vibration that can be transmitted to a cockpit and/or cabin of the fuselage 106. Most generally, the vibration control system 200 is configured to monitor and contribute to control of at least one of the sources of vibration. In some embodiments, the vibration control system 200 comprises actuators configured to selectively cause vibrations in vector directions selected to counter and/or attenuate vibrations emanating from a vibration source external to the vibration control system 200. It should be appreciated that rotorcraft 100 is merely illustrative of a variety of aircraft that can implement the embodiments disclosed herein. Other aircraft implementations can include hybrid aircraft, tilt rotor aircraft, unmanned aircraft, gyrocopters, and a variety of helicopter configurations, to name a few examples. It should be appreciated that even though aircraft are particularly well suited to implement the embodiments of the present disclosure, non-aircraft vehicles and devices can also implement the embodiments.

Referring now to FIG. 2, a simplified schematic view of the VCS 200 is shown. In some embodiments, the VCS 200 can comprise a plurality of sensors 202, such as, but not limited to, accelerometers and/or strain gauges, configured to sense vibration and provide vibration related information to a controller 204. The VCS 200 can further comprise a plurality of intermediate actuators 210 and integrated actuators 208. In some embodiments, integrated actuators 208 can comprise physical actuators, control laws, physical feedback systems, and/or any other system and/or device configured to reduce, attenuate, and/or counter the generation of vibrations. In some embodiments, intermediate actuators 210 can comprise one or more of an active pylon mounts (P-LIVE), Active Control of Structural Response (ACSR), and active engine mounts. In some embodiments, physical actuators can comprise one or more of trailing edge flaps on each rotor blade, active twist of each rotor blade, Individual Blade Control (IBC), Higher Harmonic Control (HHC) via the swashplate, and/or an active force generator mounted to a rotor hub. In some embodiments, integrated actuators 208 can affect each rotor blade individually, affect all rotor blades simultaneously (i.e. at swashplate), or the integrated actuators 208 could affect the rotor hub.

In the embodiment shown, integrated actuators 208 are provided and integrated into control of operation of the rotor system 102, the anti-torque system 108, and the engine 114. In some embodiments, intermediate actuators 210 can comprise physical actuators, control laws, physical feedback systems, and/or any other system and/or device configured to counter the transmission of generated vibrations from a source of vibrations to the a cockpit and/or cabin of the fuselage 106. The VCS 200 further comprises a dedicated actuator 212 comprising a force generation device that attached to the fuselage structure. The dedicated actuator 212 can be configured to move a mass 214 by linearly translating the mass 214 and/or rotating the mass 214 about a center point.

The dedicated actuator is connected to the cockpit and/or cabin of the fuselage 106 and contains a mass 214 that is movable relative to the fuselage 106. In some embodiments, the combination of the dedicated actuator 212 and the mass 214 can comprise a so-called seismic or inertial force generator. In some embodiments, each of the sensors 202 can communicate with a general-purpose processor system 300 of the controller 204 which is described in greater detail below. Most generally, the VCS 200 is configured to reduce vibrations transmitted to the fuselage 106 and/or to minimize audible noise within a cockpit and/or cabin of the fuselage 106. The controller 204 is generally configured to receive information from the vibration and/or noise sensors 202 and control operation of the integrated actuators 208, intermediate actuators 210, and dedicated actuator 212. In this embodiment, the controller 204 is provided with a transfer function relationship of all actively controlled actuation devices which ensures system stability and optimizes vibration suppression. In a case where an aircraft with integrated actuators, intermediate actuators, and dedicated actuators, each type of actuator having its own independent controller trying to independently control the same vibrations, it is possible that the independent control systems have an interdependent influence on each other such they are in conflict with one another. When a conflict between the independent control systems does exist, it is possible that vibrations and/or noise are increased rather than decreased by simultaneous operation of the multiple independent control systems because the independent control systems have no knowledge of the interdependent influences. Accordingly, the generated control commands to the independent control systems actuators may not be optimal, can lead to increased vibrations, can produce limit cycle oscillations, and can possibly be unstable and lead to divergent vibrations. The controller 204 can comprise and/or utilize information regarding the interdependent influence between the various actuators so that the controller 204 can overcome the deficiencies of systems comprising the same actuators controlled by separate controllers. The controller 204 can provide effective and efficient vibration reduction while additionally producing an optimal set of control commands that minimizes power and/or energy required to control the various actuators of the VCS 200. In alternative embodiments, multiple controllers can be provided that communicate with each other and share the requisite information necessary to emulate a single unified controller 204.

Most generally, the VCS 200 can be operated to measure vibrations, process the sensor measurements, and output control commands. The VCS 200 may further comprise an amplifier to produce electrical actuator drive signals to cause force generating actuators to produce force inputs to the rotorcraft fuselage 106, to a pylon 120 to fuselage 106 interface, and/or to alter the aerodynamic forces of rotor blades 104. In some cases, vibration reduction can be accomplished by superposition of the vibrations created by the actuators forces and the vibrations generated by the sources of vibration, such as the main rotor system 102. In some cases, effective vibration reduction is dependent upon the amplitude, phasing, and frequency of the forces generated by the actuators. In some cases, the controller 204 receives frequency and/or phase information from a tachometer associated with the main rotor system 102. The controller 204 can be provided with information regarding the magnitude and phase relationship between the sensors 202 and actuators 208, 210, 212 and the information can be provided in the form of a transfer function. In some cases, the transfer function can be frequency dependent, airframe design dependent, and can be time-varying through the rotorcraft 100 flight. Further, the transfer function can change as a result of RPM changes, fuel consumption, cargo changes, rotorcraft aging, and/or manufacturing differences between rotorcraft.

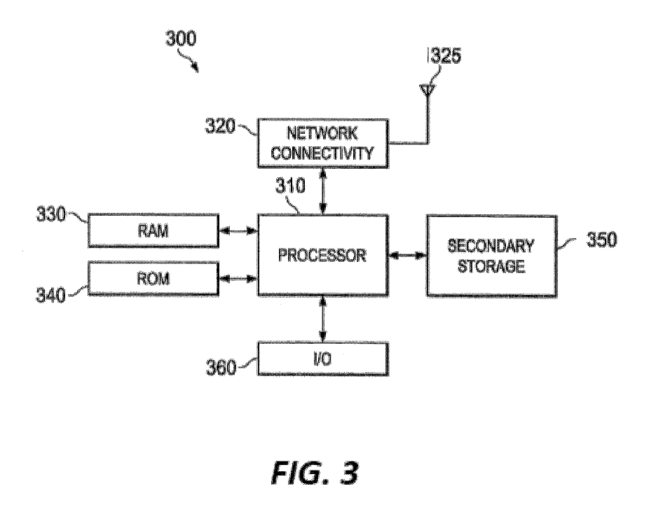

FIG. 3 illustrates a typical, general-purpose processor (e.g., electronic controller or computer) system 300 that includes a processing component 310 suitable for implementing one or more embodiments disclosed herein. In particular, the aircraft 100 may comprise one or more systems 300. In addition to the processor 310 (which may be referred to as a central processor unit or CPU), the system 300 might include network connectivity devices 320, random access memory (RAM) 330, read only memory (ROM) 340, secondary storage 350, and input/output (I/O) devices 360. In some cases, some of these components may not be present or may be combined in various combinations with one another or with other components not shown. These components might be located in a single physical entity or in more than one physical entity. Any actions described herein as being taken by the processor 310 might be taken by the processor 310 alone or by the processor 310 in conjunction with one or more components shown or not shown in the drawing. It will be appreciated that the data described herein can be stored in memory and/or in one or more databases.

The processor 310 executes instructions, codes, computer programs, or scripts that it might access from the network connectivity devices 320, RAM 330, ROM 340, or secondary storage 350 (which might include various disk-based systems such as hard disk, floppy disk, optical disk, or other drive). While only one processor 310 is shown, multiple processors may be present. Thus, while instructions may be discussed as being executed by a processor, the instructions may be executed simultaneously, serially, or otherwise by one or multiple processors. The processor 310 may be implemented as one or more CPU chips.

The network connectivity devices 320 may take the form of modems, modem banks, Ethernet devices, universal serial bus (USB) interface devices, serial interfaces, controller area network (CAN) bus interface devices, token ring devices, fiber distributed data interface (FDDI) devices, wireless local area network (WLAN) devices, radio transceiver devices such as code division multiple access (CDMA) devices, global system for mobile communications (GSM) radio transceiver devices, worldwide interoperability for microwave access (WiMAX) devices, and/or other well-known devices for connecting to networks. These network connectivity devices 320 may enable the processor 310 to communicate with the Internet or one or more telecommunications networks or other networks from which the processor 310 might receive information or to which the processor 310 might output information.

The network connectivity devices 320 might also include one or more transceiver components 325 capable of transmitting and/or receiving data wirelessly in the form of electromagnetic waves, such as radio frequency signals or microwave frequency signals. Alternatively, the data may propagate in or on the surface of electrical conductors, in coaxial cables, in waveguides, in optical media such as optical fiber, or in other media. The transceiver component 325 might include separate receiving and transmitting units or a single transceiver. Information transmitted or received by the transceiver 325 may include data that has been processed by the processor 310 or instructions that are to be executed by processor 310. Such information may be received from and outputted to a network in the form, for example, of a computer data baseband signal or signal embodied in a carrier wave. The data may be ordered according to different sequences as may be desirable for either processing or generating the data or transmitting or receiving the data. The baseband signal, the signal embedded in the carrier wave, or other types of signals currently used or hereafter developed may be referred to as the transmission medium and may be generated according to several methods well known to one skilled in the art.

The RAM 330 might be used to store volatile data and perhaps to store instructions that are executed by the processor 310. The ROM 340 is a non-volatile memory device that typically has a smaller memory capacity than the memory capacity of the secondary storage 350. ROM 340 might be used to store instructions and perhaps data that are read during execution of the instructions. Access to both RAM 330 and ROM 340 is typically faster than to secondary storage 350. The secondary storage 350 is typically comprised of one or more disk drives, tape drives, or solid-state drives and might be used for non-volatile storage of data or as an over-flow data storage device if RAM 330 is not large enough to hold all working data. Secondary storage 350 may be used to store programs or instructions that are loaded into RAM 330 when such programs are selected for execution or information is needed.

The I/O devices 360 may include liquid crystal displays (LCDs), touch screen displays, keyboards, keypads, switches, dials, mice, track balls, voice recognizers, card readers, paper tape readers, printers, video monitors, transducers, sensors, or other well-known input or output devices. Also, the transceiver 325 might be considered to be a component of the I/O devices 360 instead of or in addition to being a component of the network connectivity devices 320. Some or all of the I/O devices 360 may be substantially similar to various components disclosed herein.

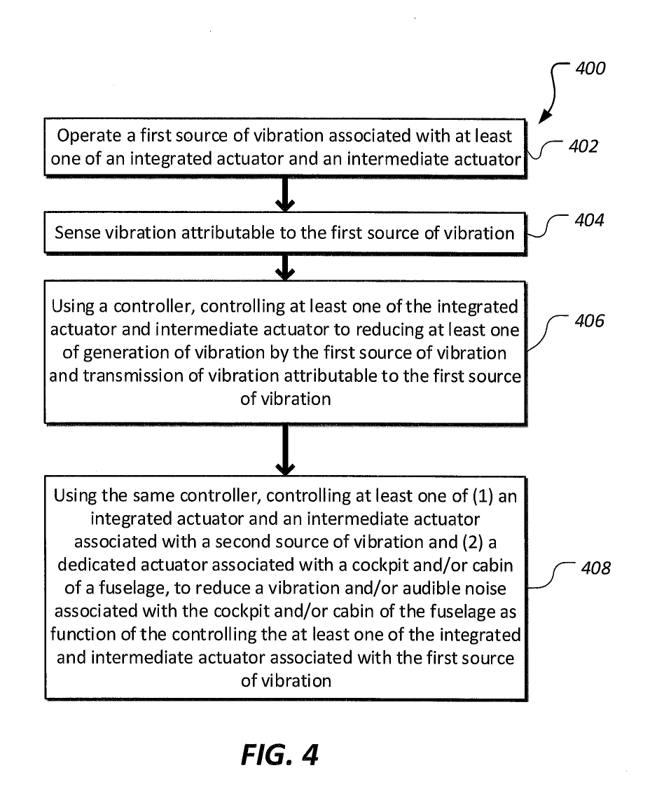

Referring now to FIG. 4, a flowchart of a method 400 of operating the VCS 200 is shown. The method 400 can begin at block 402 by operating a first source of vibration, such as, but not limited to, operating a rotor system 102, anti-torque system 108, or engine 114. In some oases, vibrations will normally be generated by operating the first source of vibration. The method 400 can continue at block 404 by sensing the vibrations generated by the first source of vibration using sensors, such as, but not limited to, one or more sensors 202. The method 400 can continue at block 406 by using a controller to, in some embodiments, utilize the sensed information regarding vibrations from the first source of vibration to control at least one of an integrated actuator and intermediate actuator associated with the first source of vibration to reduce at least one of the generation of vibration by the first source (using an integrated actuator) and the transmission of vibration attributable to the first source of vibration (using an intermediate actuator). In some embodiments, the above-described controlling can be accomplished utilizing a controller, such as, but not limited to, controller 204. In some embodiments, the method 400 can continue at block 408 by operating the same controller utilized to control, as a function of the sensing and/or controlling associated with the first source of vibration, at least one of an integrated actuator associated with a second source of vibration, an intermediate actuator associated with the second source of vibration, and a dedicated actuator associated with a cockpit and/or cabin of a fuselage to reduce a vibration and/or audible noise associated with the cockpit and/or cabin of the fuselage.

In other words, the method 400 can utilize a controller to control actuators associated with multiple sources of vibration while taking into consideration the operation of all actuators controlled by the controller. In some cases, the above-described unified control of the actuators can prevent actuators from engaging in actuations that generate directional forces that exacerbate and/or amplify undesirable vibrations. Further, the method 400 can allow unification of control over previously separately operated actuators so that actuation control is administered efficiently and without creating force fighting between actuators. Still further, the method 400 provides for operating a VCS, such as VCS 200, so that the vibration reduction accomplished by operating an actuator associated with a first source of vibration can be complemented by, as a function of the control of the actuator associated with the first source of vibration, additionally operating a dedicated actuator associated with a fuselage to reduce vibration and/or audible noise associated with a cockpit and/or cabin of the fuselage.

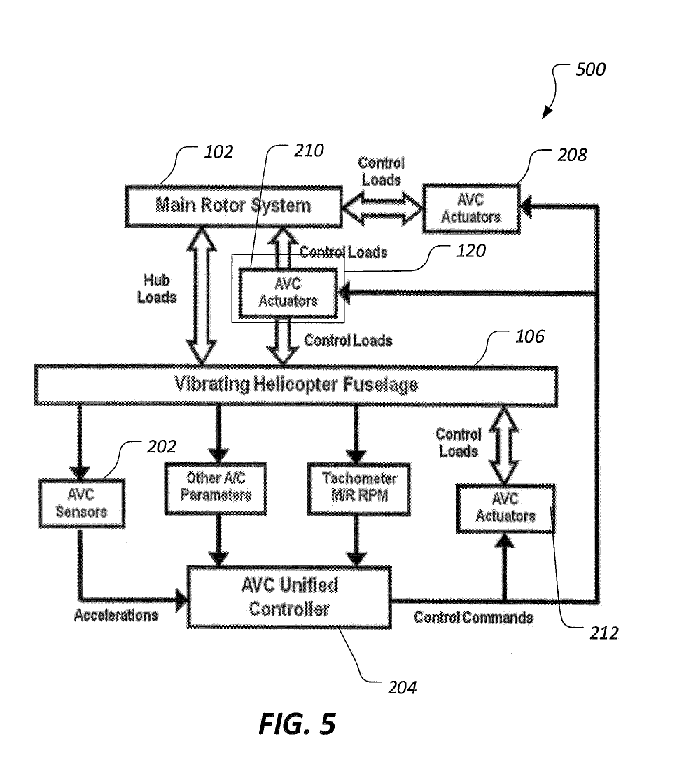

Referring now to FIG. 5, a schematic representation of an alternative embodiment of a VCS is shown. The VCS 500 is substantially similar to VCS 200 and comprises sensors 202, integrated actuators 208, intermediate actuators 210, and dedicated actuators 212. In this embodiment feedback from sensors 202 is provided to the controller 204 and the controller 204 is configured to issue control commands to each of the integrated actuators 208, intermediate actuators 210, and dedicated actuators 212. In this embodiment, the integrated actuators 208 are associated with the main rotor system 102 and can comprise components and/or control laws configured to affect operation of the main rotor system 102, such as, but not limited to, a torque applied to the main rotor system, a pitch of one or more rotor blades 104, trailing edge flap values, and/or any other suitable input selected to adjust control operation and/or a physical configuration of the main rotor system 102 in a manner selected to reduce vibration generated by the main rotor system. In this embodiment, the main rotor system 102 can be referred to as a first source of vibration. The main rotor system 102 is mechanically connected to the fuselage 106 via the pylon mounting system 120. As such, in some cases the vibrations produced by the main rotor system 102 can be transmitted to the fuselage 106 via the pylon mounting system 120. In this embodiment, the pylon mounting system 120 is associated with intermediate actuators 210. Intermediate actuators 210 can be disposed in a load path between the main rotor system 102 and the fuselage 106 so that selective operation of the intermediate actuators 210 can reduce transmission of vibratory forces between the main rotor system 102 and the fuselage 106.

In operation, the VCS 500 can reduce vibration and/or audible noise in a cockpit and/or cabin of the fuselage 106 by feeding information from sensors 202, information from a tachometer associated with the main rotor system 102, and other A/C parameters to the unified controller 204. Because the controller 204 is provided with a transfer function defining the relationships between the actuators 208, 210, 212, the controller 204 can be utilized to calculate and issue appropriate control commands for each of the actuators 208, 210, 212. In some embodiments, the transfer functions can provide information defining a relationship between the vibration sensors and the actuators, as well as interdependent relationships between the various actuators. In some embodiments, the control commands to the actuators 208 comprise adjustments to rotor blade 104 operation, such as, but not limited to pitch adjustments. In some embodiments, the control commands to the actuators 210 comprise control signals for generating force inputs to at least one of the main rotor system 102 and the fuselage 106. In some embodiments, the force inputs can be accomplished by extending and/or retracting a piston of an actuator that lies along a force path between the main rotor system 102 and the fuselage 106. In some embodiments, the control commands to the actuator 212 can comprise control signals to an inertial force generator that generally moves a mass 214 relative to the fuselage 106. The control commands to the actuators 208, 210, 212 can comprise frequency, direction, phase, and/or amplitude information. In some embodiments, one or more sensors 202 can be disposed relative to a particular location of a fuselage, such as, but not limited to, a pilot seat to optimize vibration and/or audible noise reduction for the selected locations, such as selected locations within an aircraft fuselage.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A vibration control system for a rotorcraft, comprising:
at least one of an integrated actuator and an intermediate actuator associated with a first source of vibration;
a sensor configured to sense vibration from the first source of vibration;
a dedicated actuator configured for association with a fuselage; and
a controller configured to receive information from the sensor and configured to control the dedicated actuator and the at least one of the integrated actuator and the intermediate actuator.

2. The vibration control system of claim 1, wherein the first source of vibration comprises a main rotor system.

3. The vibration control system of claim 1, wherein the integrated actuator is configured to affect operation of a rotor system.

4. The vibration control system of claim 1, wherein the intermediate actuator is associated with a pylon mounting system.

5. The vibration control system of claim 1, wherein the dedicated actuator comprises an inertial force generator.

6. The vibration control system of claim 1, wherein the first source of vibration comprises an anti-torque system.

7. The vibration control system of claim 1, wherein the first source of vibration comprises an engine.

8. A method, comprising:
operating a first source of vibration of a rotorcraft;
sensing vibration attributable to the first source of vibration;
to reduce at least one of a vibration and an audible noise associated with a fuselage of the rotorcraft, operating a controller to receive the sensed vibration, control at least one of an integrated actuator associated with the first source of vibration and an intermediate actuator associated with the first source of vibration, and control at least one of (1) an integrated actuator associated with a second source of vibration and an intermediate actuator associated with the second source of vibration and (2) a dedicated actuator associated with a fuselage of the rotorcraft.

9. The method of claim 8, wherein the first source of vibration comprises a main rotor system of the rotorcraft.

10. The method of claim 8, wherein the integrated actuator associated with the first source of vibration is configured to affect vibration produced by a main rotor system.

11. The method of claim 8, wherein the intermediate actuator associated with the first source of vibration is further associated with a pylon mount system.

12. The method of claim 8, wherein the second source of vibration comprises an anti-torque system of the rotorcraft.

13. The method of claim 8, wherein the second source of vibration comprises an engine of the rotorcraft.

14. The method of claim 8, wherein the dedicated actuator is further associated with a mass that is movable relative to the fuselage.

15. The method of claim 14, wherein the dedication actuator comprises an inertial force generator.

16. A helicopter, comprising:
a main rotor system;
a fuselage;
a pylon mount system connected between the main rotor system and the fuselage;
at least two of an integrated actuator associated with the main rotor system, an intermediate actuator associated with the main rotor system, and a dedicated actuator associated with the fuselage;
a sensor configured to sense vibration generated by the main rotor system; and
a controller configured to receive information from the sensor and configured to control at least two of the integrated actuator associated with the main rotor system, the intermediate actuator associated with the main rotor system, and the dedicated actuator associated with the fuselage.

17. The helicopter of claim 16, wherein the dedicated actuator comprises an inertial force generator.

18. The helicopter of claim 16, wherein the sensor comprises an accelerometer or a strain gauge.

19. The helicopter of claim 16, wherein the intermediate actuator is further associated with the pylon mounting system.

20. The helicopter of claim 16, wherein the controller is configured to control each of the integrated actuator associated with the main rotor system, the intermediate actuator associated with the main rotor system, and the dedicated actuator associated with the fuselage.
